(19) United States
(12) Patent Application Publication
(10) Pub. No.: US 2024/0167302 A1
(43) Pub. Date: May 23, 2024

(54) ELECTRICAL COMPONENT PROTECTION USING ONE OR MORE COMPRESSIVE ELEMENTS

(71) Applicant: Magna Closures Inc., Newmarket (CA)

(72) Inventors: Francesco BIASCI, Newmarket (CA); Enrico BOERI, Newmarket (CA); Alessandro CARLI, Newmarket (CA)

(21) Appl. No.: 18/386,477

(22) Filed: Nov. 2, 2023

Related U.S. Application Data
(60) Provisional application No. 63/384,863, filed on Nov. 23, 2022.
(60) Provisional application No. 63/460,233, filed on Apr. 18, 2023.

(51) Int. Cl. E05B 81/50; E05B 81/16; E05B 81/86

(52) U.S. Cl. CPC E05B 81/50; E05B 81/16; E05B 81/86

(57) ABSTRACT

An electronic closure latch assembly for a vehicle, the electronic closure latch assembly comprising: an enclosure cover; a component portion of the enclosure cover sized to retain an electrical component therein, the component portion having an interior having a plurality of compression elements distributed on an interior surface of the interior; an electronic controller disposed within the enclosure cover, the electronic controller including the electrical component; wherein the plurality of compression elements are deformed against an exterior surface of the electrical component when the electrical component is inserted into the component portion of the enclosure cover.

### CROSS-REFERENCE TO RELATED APPLICATION

This application claims priority from the benefit of the filing date of U.S. Provisional Patent Application No. 63/384,863 filed on Nov. 23, 2022, entitled “ELECTRICAL COMPONENT PROTECTION USING A COMPRESSIVE FIT CAP”; and Provisional Patent Application No. 63/460,233 filed on Apr. 18, 2023, entitled “ELIMINATION OF RESIN IN SUPERCAP AREA”, the contents of which are herein incorporated by reference.

### TECHNICAL FIELD

The present invention relates generally to an enclosure assembly for an electronic controller and more particularly to assembly of components.

### BACKGROUND

This section provides background information related to the present disclosure which is not necessarily prior art.

Continued increases in technology permit more and more features to be added to modern vehicles, particularly electronic components and electronic controllers. The electronic controllers receive, process and transmit a variety of electrical data. These electronic controllers and their associated electronic components are used to control a wide variety of functions in the vehicle including common examples such as power windows, power latches for doors and other vehicle panels, motion sensitive locking mechanisms, remote sensing features, garage door openers, touch sensitive combination locks for doors, moon roof controls, seating controls, audio controls, motion sensors, position sensors, and crash sensors. Many times it is most advantageous to have the electronic controllers associated close to the actual mechanisms they control. Thus, for example, one designs an electronic controller for a door latch to be built into the door panel right next to the mechanical locking feature it controls. Typically these electronic controllers include a circuit board, which may be a printed circuit board, to control the mechanical features based on the circuits and electrical components on the board. These circuit boards and electronic controllers are sensitive to environmental damage so they need to be covered and protected from the elements. This is typically done by enclosing them within an enclosure assembly having a housing, often formed from a hard plastic material, and it may include O-ring type seals to prevent ingress of dirt and moisture. Generally the housing is large enough to accommodate the electrical controllers and electrical components with room to spare so that assembly of the entire enclosure assembly can be rapidly accomplished on an assembly line. The enclosure assembly with the electronic controller in it is then mounted to a location on or inside the vehicle. For example, an electronic controller for a latch mechanism might be mounted inside a door of a vehicle and secured to an interior door panel.

One issue with current enclosure assemblies, especially those used to control latches of vehicle panels and doors, is that with use of the door the electrical controller, electrical components and circuit board are subjected to deceleration forces as the door reaches the end of its travel both when it is opened and when it is shut. The door is accelerated from an open position to a closed position or vice versa and then the motion is abruptly stopped as the door reaches its final opened or closed position. These deceleration forces can be significant. As the mass of the part increases the force it is subjected to increases. Many latches are “smart latches” meaning a portion of their action is automatic. So for example many door latches are designed to automatically lock when a vehicle reaches a pre-determined velocity. One feature that is needed for many of these electronic controllers, especially those used in “smart” environments, is the ability to provide power to the circuit board in the event of loss of power from the vehicle battery such as in an accident, interruption of the electrical connection from the battery, or the event of a dead battery. To deal with this issue designers are mounting capacitors, super capacitors and backup batteries onto the circuit board to provide power to the electronic controller in the event of a loss of power from the vehicle battery. These backup power devices are much larger than most other components typically found on the circuit board and thus they are also subjected to higher forces during deceleration events in opening and closing of the door. The deceleration forces can cause the electrical components to be jarred while on the circuit board, they can be damaged internally, and they can detach from the circuit board.

These components need to be protected from these deceleration forces. In addition, some enclosure assemblies do not hold the circuit board tightly and as a result, the circuit board rattles in the enclosure assembly during operation of the vehicle, thereby generating noise, which can negatively affect the impression of quality of the vehicle to its owner. This rattling can also damage the electrical components found on the circuit board. Further, the provision and installation the super capacitors into the latch needs to compensate for variations in latch housing sizes and/or supercap sizes, and a variety of potential assembly processes.

It is desirable to provide an enclosure assembly that can protect the electrical components against deceleration forces, that is cost effective to implement and that can easily adapted to a variety of enclosure designs.

Further, it is important in automotive systems to provide protection from vibration for certain electrical components, for example an electrolytic capacitor. However, current designs use a resin injected between the electrolytic capacitor and an adjacent housing, however this process has a disadvantage of cost and waste recovery issues (during disassembly post resin cure). Further, the use of resin may prevent a latch assembly from being opened due to the infiltration of liquid resin throughout other parts of the latch assembly.

### SUMMARY OF THE INVENTION

It is an object of the present invention to provide an assembly for electronic components to obviate or mitigate at least one of the above presented disadvantages.

A first aspect provided is an electronic closure latch assembly for a vehicle, the electronic closure latch assembly comprising: an enclosure cover; a component portion of the enclosure cover sized to retain an electrical component therein; an electronic controller disposed within the enclosure cover, the electronic controller including the electrical component; and a cap disposed inside the component portion between the electrical component and a wall of the component portion, the cap having at least a portion of the cap being a resilient material; wherein the at least a portion of the cap is deformed against the wall when the electrical component is inserted into the component portion of the enclosure cover.

A second aspect provided is a method of assembling an electronic closure latch assembly, the method comprising: providing an enclosure cover of an electronic latch assembly, the enclosure cover having at least one cavity formed therein as a component portion for receiving an electrical component; fitting a cap to at least a portion of the electrical component to form a subassembly; and disposing the subassembly within the cavity of the component portion; wherein the at least a portion of the cap is deformed against the wall when the subassembly is inserted into the component portion of the enclosure cover.

A third aspect provided is a method of assembling an electronic closure latch assembly, the method comprising: providing an enclosure cover of an electronic latch assembly, the enclosure cover having at least one cavity formed therein as a component portion for receiving an electrical component; providing an overmolded a cap on a wall forming an interior of the cavity; and disposing the electrical component within the cavity of the component portion; wherein at least a portion of the cap is deformed between the electrical component and the wall when the electrical component is inserted into the component portion of the enclosure cover.

A fourth aspect provided an electronic closure latch assembly for a vehicle, the electronic closure latch assembly comprising: an enclosure cover; a component portion of the enclosure cover sized to retain an electrical component therein, the component portion having an interior having a plurality of compression elements distributed on an interior surface of the interior; an electronic controller disposed within the enclosure cover, the electronic controller including the electrical component; wherein the plurality of compression elements are deformed against an exterior surface of the electrical component when the electrical component is inserted into the component portion of the enclosure cover.

A fifth aspect provided is a method of assembling an electronic closure latch assembly, the method comprising: providing an enclosure cover of an electronic latch assembly, the enclosure cover having at least one cavity formed therein as a component portion for receiving an electrical component, the component portion having an interior having a plurality of compression elements distributed on an interior surface of the interior; and disposing the electrical component into the component portion such that an interference it is formed by deformation of the plurality of compression elements by an exterior surface of the electrical component.

### BRIEF DESCRIPTION OF THE DRAWINGS

The non-limiting embodiments may be more fully appreciated by reference to the following detailed description of the non-limiting embodiments when taken in conjunction with the accompanying drawings, by example only, in which:

FIG. 1 shows a perspective view of a vehicle having an electronic latch assembly;

FIG. 2 is an example embodiment of the electronic latch assembly of FIG. 1;

FIG. 3a is a top view of an example latch mechanism of the latch assembly of FIG. 1;

FIG. 3b is a bottom view of the example latch mechanism of FIG. 3a;

FIG. 4 is an example PCB of a controller of the electronic latch assembly of FIG. 1;

FIG. 5 is a further example embodiment of the controller of FIG. 4 including an ECU enclosure;

FIGS. 6, 7, 8 provides exploded and assembled views of a cap, an electronic component and a component enclosure portion of the ECU enclosure of FIG. 5;

FIG. 9 is an example pictorial view of an example assembly using the cap of FIGS. 6,7,8;

FIG. 10 shows an example method of assembly using the cap of FIGS. 6,7,8; and

FIG. 11 shows an example method of manufacture including the cap of FIGS. 6,7,8.

FIG. 12 is an underside view of the ECU enclosure of FIG. 5;

FIG. 13 is an underside view of the ECU enclosure of FIG. 5 including compression elements;

FIG. 14a shows an assembled view of the electrical component with the enclosure of FIG. 13;

FIG. 14b shows an unassembled top view of the enclosure of FIG. 13;

FIG. 15 shows a further assembled view of the electrical component with the enclosure of FIG. 14a;

FIG. 16a shows an alternative embodiment of the compression elements of FIG. 13;

FIG. 16b shows an exterior view of the enclosure of FIG. 16a;

FIG. 17a shows an unassembled top view of the enclosure of FIG. 16a;

FIG. 17b shows an assembled view of the electrical component with the enclosure of FIG. 16a;

FIG. 18 shows an example method of manufacture including the enclosure of FIG. 12 with any of the compression element embodiments;

FIG. 19 shows a further embodiment of the component portion of FIG. 12;

FIG. 20 shows an enlarged view of the further embodiment of the component portion of FIG. 19;

FIG. 21 shows an unassembled view of the component portion of FIG. 19; and

FIGS. 22 and 23 show an assembled view of the component portion of FIG. 19.

### DETAILED DESCRIPTION

Referring now to the drawings and the illustrative embodiments depicted therein.

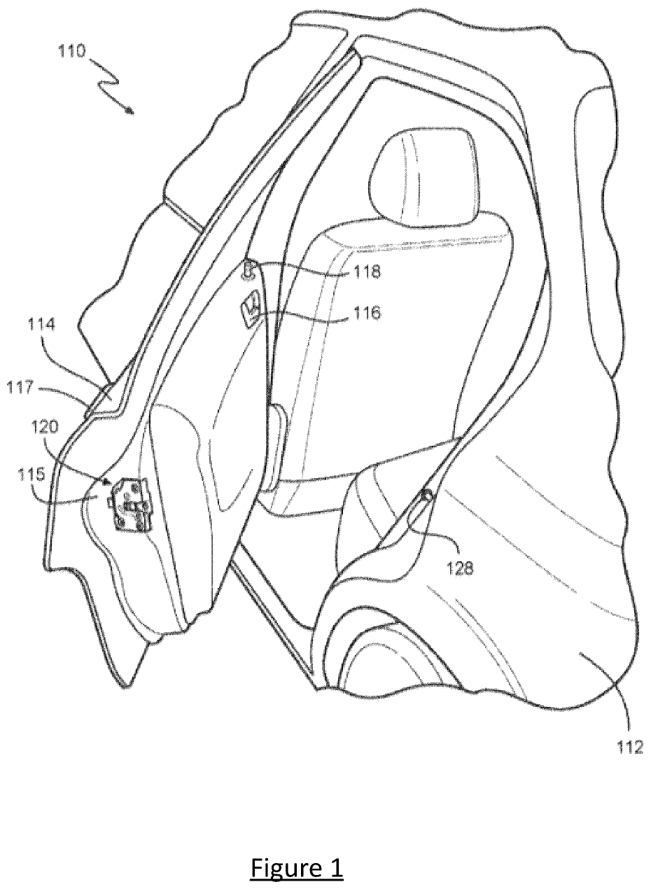

FIG. 1 is a perspective view of a vehicle 110 that includes a vehicle body 112 and at least one vehicle door 114 (also referred to as closure panel 114). The vehicle door 114 includes a latch assembly 120 that is positioned on an edge face 115 and which is releasably engageable with a striker 128 on the vehicle body 112 to releasably hold the vehicle door 114 in a closed position. An outside door handle 117 and an inside door handle 116 are provided for opening the latch assembly 120 (i.e. for releasing the latch assembly 120 from the striker 128) to open the vehicle door 114. An optional lock knob 118 is shown and provides a visual indication of the lock state of the latch assembly 120 and may be operable to change the lock state between an unlocked position and a locked position.

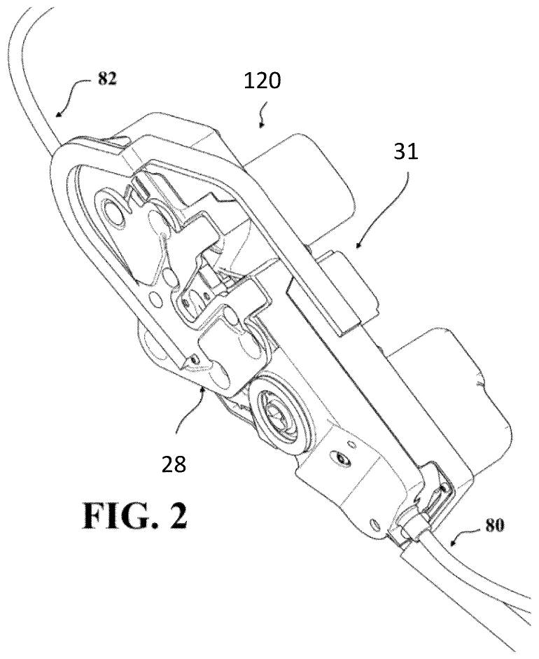

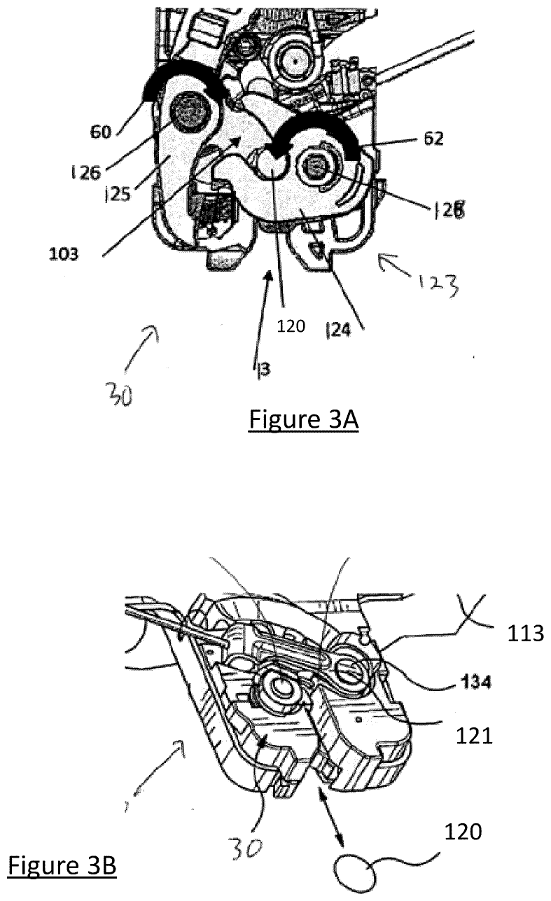

Referring to FIG. 2, the closure latch assembly 120 is generally comprised of a latch module 28, an actuator module 31, and a power cable 80 connecting the actuator module 31 to a power source (e.g. battery—not shown). Further, a latch module 28 includes a latch mechanism 30 (FIGS. 3a and 3b) operable to engage the striker 128 and releaseably hold closure panel 112 in one of its partially-closed and fully-closed positions. Further, a linkage 80 (e.g. latch linkage 80) can be coupled to one or more latch components 123 (e.g. ratchet 124 and/or pawl 125 as further described below). As such, the latch mechanism 28 can be actuated (e.g. manually) by the linkage 80 to operate the closure panel 112.

Referring to FIGS. 3a, 3b, the example mechanism configuration of the latch 30 has a frame 113 mounted on the door 112. The latch 30 is oriented on the door 112 so as to be aligned to engage the mating latch component (e.g. striker 120). The linkage 82 (e.g. cinch linkage 82) can be coupled to a member 121 (e.g. cinch arm) and also to one or more latch components 123 (e.g. ratchet 124 and/or pawl 125). As such, the member 121 can be actuated (e.g. pulled) by the actuator linkage 82 to operate the door 112 from a partially closed position to a fully closed position, (e.g. a cinched position), as the member 121 can be coupled to the ratchet 124 via a cinch lever arm. For example, the member 121 is connected to the cinch arm by pivot 134 and the cinch arm can be coupled to the ratchet 124 by a pin. It is also recognized that the actuator linkage 82 can be provided as a rigid linkage rather than as a flexible linkage involving cables. For example, the actuator linkage 82 can be embodied as a sector gear (or other series of rigid members) connected to the member 121 and/or the cinch lever at one end of the actuator linkage 82.

The latch 30 includes the number of latch elements 123 (e.g. ratchet 124, actuator linkage 82, cinch member 121 and pawl 125) that are configured to cooperate with the striker 128 in order to retain the striker 128 within a slot 13 when the door 112 is in the closed position (e.g. locked), or otherwise to drive the striker 128 out of the slot 13 when the door 112 is moved towards the open position. The slot 13 is sized for receiving the striker 128 therein, in other words the slot 13 of the latch 30 cooperates with a slot 103 of the ratchet 124. The slot 13 has an open top end and a closed bottom end as shown. The latch elements 123 of the ratchet 124 and pawl 125 are pivotally secured to the frame 113 via respective shafts 128, 126. Note that in FIG. 3a, the latch 30 with associated ratchet 124 is shown in the fully or primary closed position (e.g. a cinched position). Rotation 60 about shaft 126 causes the pawl 125 to release the ratchet 124, thus allowing the ratchet 124 to rotate 62 about the shaft 126 and thus release the striker 128 from both the slot 13 and the slot 103. Contrary to the opening sequence of the latch 30, once the striker 128 is subsequently received in the slots 13,103 upon closing of the door 112, actuation of the actuator linkage 82 causes movement of the member 121 and coupled cinch lever arm in order to rotate the ratchet 124 about the shaft 128 counter to the rotation 62 (shown) and thus cinch the striker 128 within the slots 13,103.

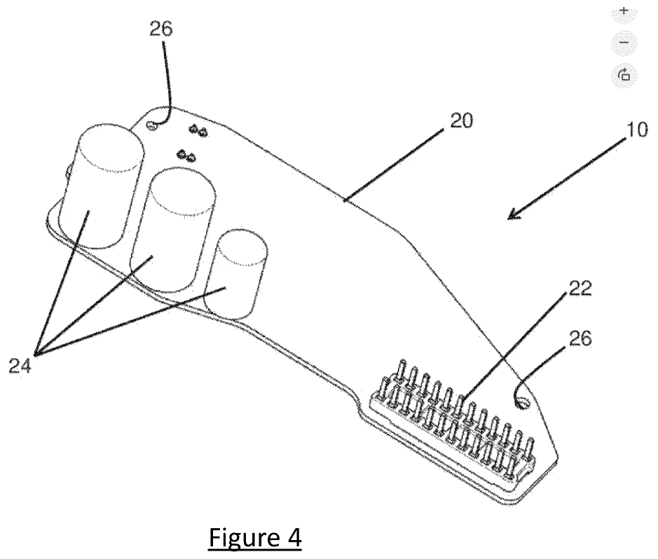

FIG. 4 shows a schematic representation of a stylized electronic controller 10 of the latch assembly 120 comprising a printed circuit board 20 having attached thereto a plurality of electrical components 24. The stylized electronic controller shown at 10 is meant to be for illustration purposes only and not to limit the shape, functionality or design of any electronic controller (EC) that might be used with the present disclosure. The circuit board 20 is also shown as having an optional terminal block 22 mounted thereto. The circuit board 20 further comprises one or more holes 26 that can be used to locate the electronic controller 10 within an enclosure assembly cover 151, discussed below, and/or to secure it to an enclosure assembly. The circuit board 20 may be any suitable type of circuit board, such as a printed circuit board and may have a plurality of electrical components 24 soldered thereto as shown. The circuit board 20 may be formed from any suitable material such as an epoxy resin reinforced with glass-fiber. As discussed, it is important to provide a snug fit between the electrical components 24 and adjacent surfaces of the assembly cover 151, as further described below, taking into account the possibility of different sized covers 151 for the same electrical component 24 and/or taking into account the possibility of same sized/configured covers 151 for different sized/number of electrical component 24.

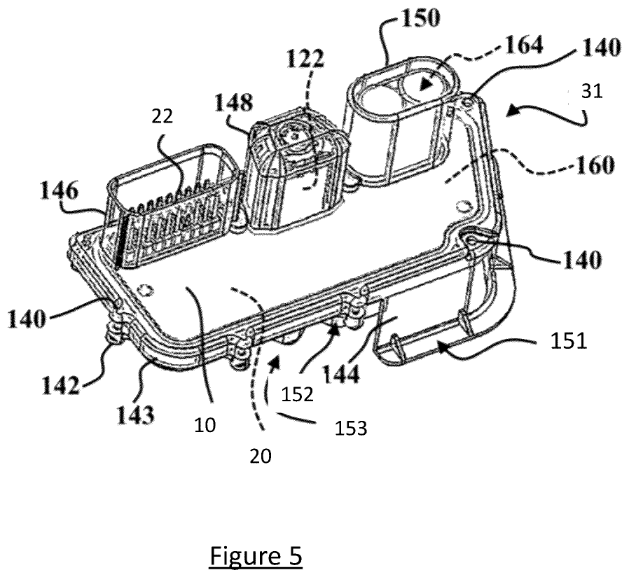

The electrical components 24 (e.g. super capacitors 164—see FIG. 5 for a supercap 164 within the latch housing) can have any shape or size and the shapes and sizes shown in FIG. 1 are for illustration purposes only. The electrical components 24 can comprise a variety of electrical components including, for example, a processor, a relay, a connector to a daughter board or a daughter board, a backup battery, a capacitor, a super capacitor, or a terminal block 22. The terminal block 22 permits the connection of the electronic controller 10 to other electrical components such as an external power source (e.g. the vehicle's low-voltage battery system via cable 80) and for communication with other devices in the vehicle. The low-voltage battery system may refer to a 12V battery system, a 42V battery system or some other voltage. The term ‘low-voltage’ is intended to distinguish the battery system from the high-voltage battery system found on vehicles that have an electric traction motor. For greater certainty, it will be understood that the controller 10 may be used in vehicles that have electric traction motors and also vehicles that do not have such motors.

FIG. 5 illustrates an example ECU cover 151 (shown in transparent mode for clarity) disposed about housing plate 152 and mounted on ECU/actuator assembly 153 with a plurality of mounting apertures 140 formed in ECU cover aligned with a similar plurality of alignment bores 142 formed in housing plate 152 of ECU/actuator assembly 153. A suitable fastening mechanism, such as mechanical fasteners, including rivets, screws, and bolts, by way of example and without limitation, define attachment arrangement 26 and are installed in aligned pairs of mounting apertures 140 in ECU cover 151 and alignment bores 142 in housing plate 152 to secure actuator module 31 to latch module 28 (see FIG. 2). ECU cover 151 can include a plate segment 143, a peripheral shroud segment 144 extending outwardly from a plane of plate segment 143, and a plurality of upstanding enclosure segments 146, 148, 150 also extending outwardly from a plane of plate segment 143, shown as extending in an opposite direction from plate segment 143 as shroud segment 144. Enclosure segments (e.g. cover portions) 146, 148, 150 of ECU cover 151 are configured to receive and enclose distinct components (e.g. such as super capacitors 164) associated with control unit 10.

Specifically, plate segment 143 is arranged to accommodate and enclose a printed circuit board (PCB) 20 which has been encapsulated/over-molded onto a first surface of housing plate 152. Likewise, enclosure segment 146 is a connector housing surrounding a plurality of connector contacts 22 extending from PCB 20 to define an electrical connector. In addition, enclosure segment 148 is a motor housing configured to enclose electric motor 122 which is mounted to carrier plate and which, in turn, is encapsulated/over-molded on the first surface of housing plate 152. Finally, enclosure segment 150 (having a cavity or interior 66) can be a capacitor housing configured to enclose one or more backup power devices, such as Super Capacitors 164 electrically connected to PCB 20. A peripheral seal (not shown) surrounds plate segment 143 of housing plate 152 and hermetically seals the first surface of housing plate 152 relative to ECU cover 151 to inhibit the ingress of fluid and other forms of potential contamination there between.

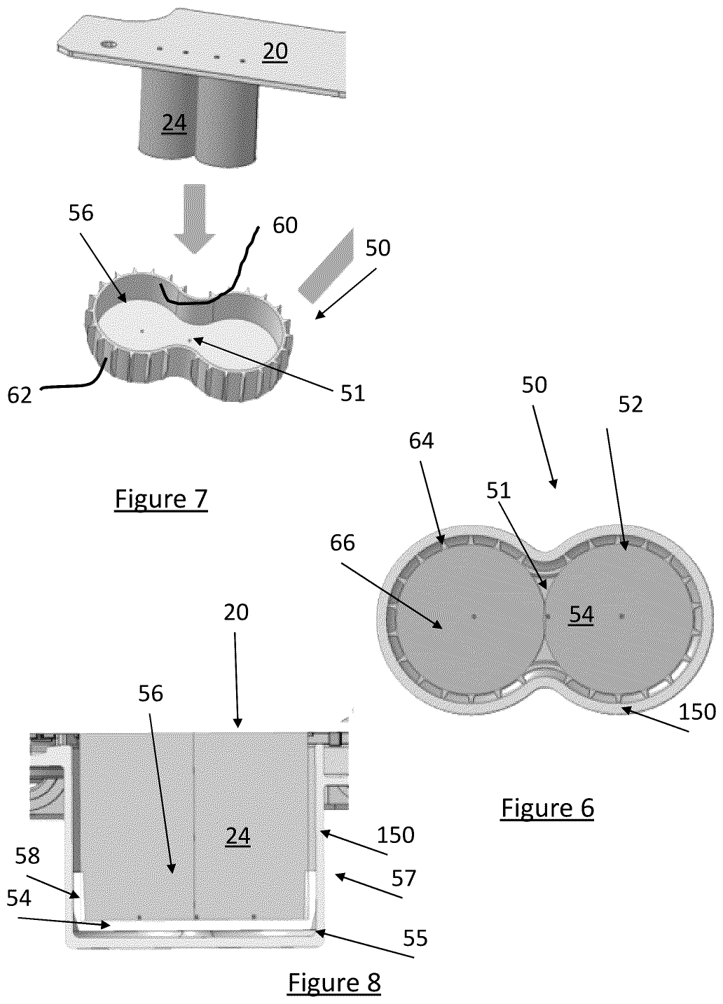

Referring to FIGS. 6, 7, 8, shown is a (e.g. separate) cap 50 having a body 52 with a base 54 at one end 55 and an opening 56 at another end 57. Extending between the ends 55, 57, the body 52 has a sidewall 58 having an interior surface 60 and an exterior surface 62. The exterior surface 62 has a plurality of ribs 64 spaced apart about a periphery of the sidewall 58, such that the ribs 64 project outwards from the exterior surface 60. The base 54 and the sidewall 58 define an interior 66, which can be referred to as a receptacle for receiving at least a portion of the electronic component 24 (e.g. a super cap). For example, the body 52 can be made of a resilient material (e.g. rubber). For example, the ribs 64 can be made of a resilient material (e.g. rubber). For example, the body 52 can be made of a non-resilient material (e.g. hard or stiff rubber or plastic), such that the ribs 64 are made of a resilient material (such as flexible rubber). It is recognised that the rib 64 structures are resilient such that they that collapse (e.g. bend or otherwise deform or compress) during the insertion process of the cap 50 (with electronic component 24 fitted into the interior 66) into the component enclosure 150 (e.g. electrical component 24 housing). As such, during bending or other deformation of the ribs 64, a compressive fit of the cap 50 between the electrical component 24 and the component enclosure 150 provides for a snug fit with the electrical component 24 within the component enclosure 150 in order to facilitate compensation for variations in latch housing 150 sizes and/or super cap 24 sizes, and or assembly processes thereof as desired.

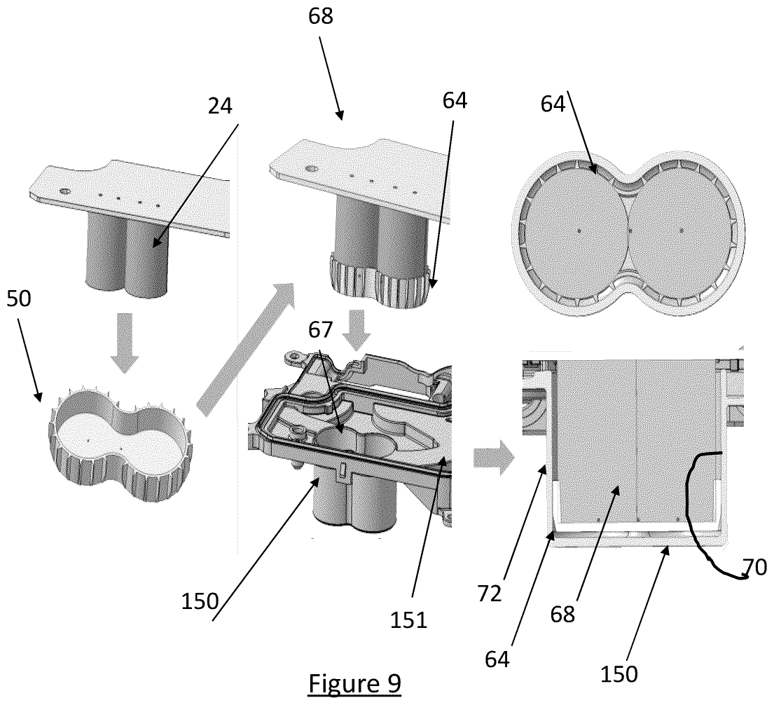

FIG. 9 shows pictorially an example assembly process using the cap 50, the one or more components 24 and the ECU cover 151 including the component enclosure 150. As such, the electrical component 24 is first inserted into the cap 50, such that the ribs 64 are now projecting outwards. The cap 50 and the electrical component 24 (with attached PCB 20) are provided as a subassembly 68, which is then inserted into the component enclosure 150 portion of the ECU cover 151, such that the ribs 24 are deformed against an inside surface 70 of a wall 72 (defining a cavity 67) of the component enclosure 150.

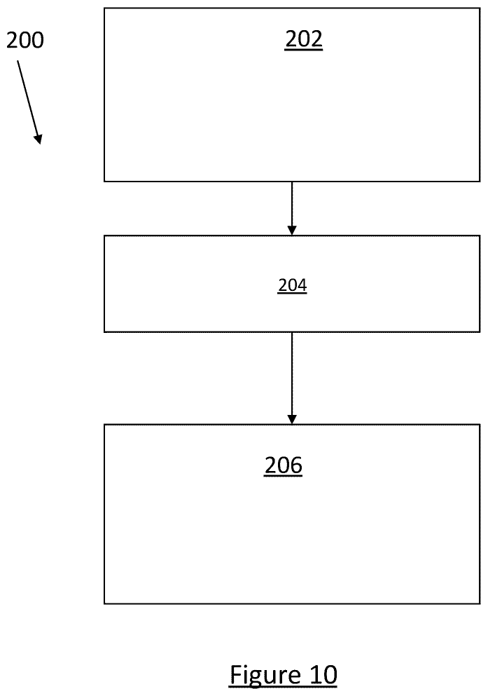

FIG. 10 shows a method 200 of assembly for the cap 50, the electrical component(s) 24 and the utilized component enclosure portion 150 of the ECU cover 151. As such, it is recognised that the ribs 64 engage with the inside surface 72 of the enclosure portion 150 (see FIG. 9). The steps include: step 202 to form the cap 50 (with the shape of one or more of the supercaps) having extending ribs 64 such that the body 52 of the cap 50 conforms to an exterior surface of the electrical component(S) 24; step 204 of fitting the cap 50 to the electrical component(s) 24 (into engagement with the supercaps such that it is engaged with the top); and step 206 inserting the subassembly 68 into the enclosure 150 (i.e. insert the supercaps with the fitted endcaps into engagement with the latch housing), such that the extending ribs engage with either the inside of the housing or with the supercap).

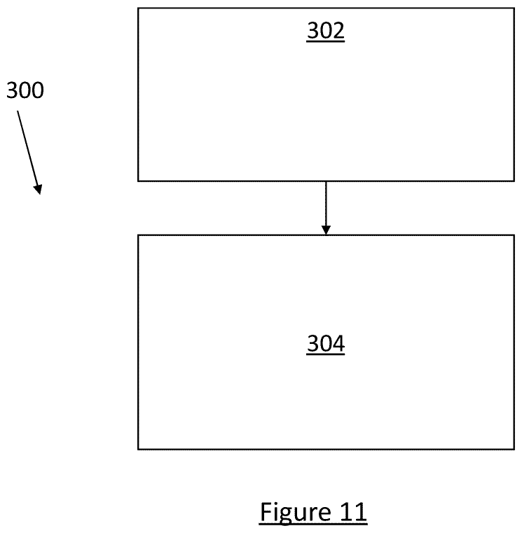

FIG. 11 shows an example method of manufacturing 300 including steps 302 and 304 concerning forming the cap 50 as an overmold on the inside surface 70 of the wall 72 of the component enclosure 150. For example, form latch housing with interconnected compartments for super cap with form channel connecting compartments, and form cap having an interconnecting member between supercap engagement portions, where interconnecting member is configured to extend through the channel when the cap and supercaps are inserted into the compartments. In this embodiment, the cap 50 may not be a separate piece from both the electrical component 24 and the enclosure portion 150, rather the cap 50 is considered an integral part of the enclosure portion 150 as an applied overmold as given by example. In this example, the interconnecting member can also be referred to as a rib 64, suc that the rib 64 is formed as part of the overmolding process (e.g. a plurality of interconnecting members).

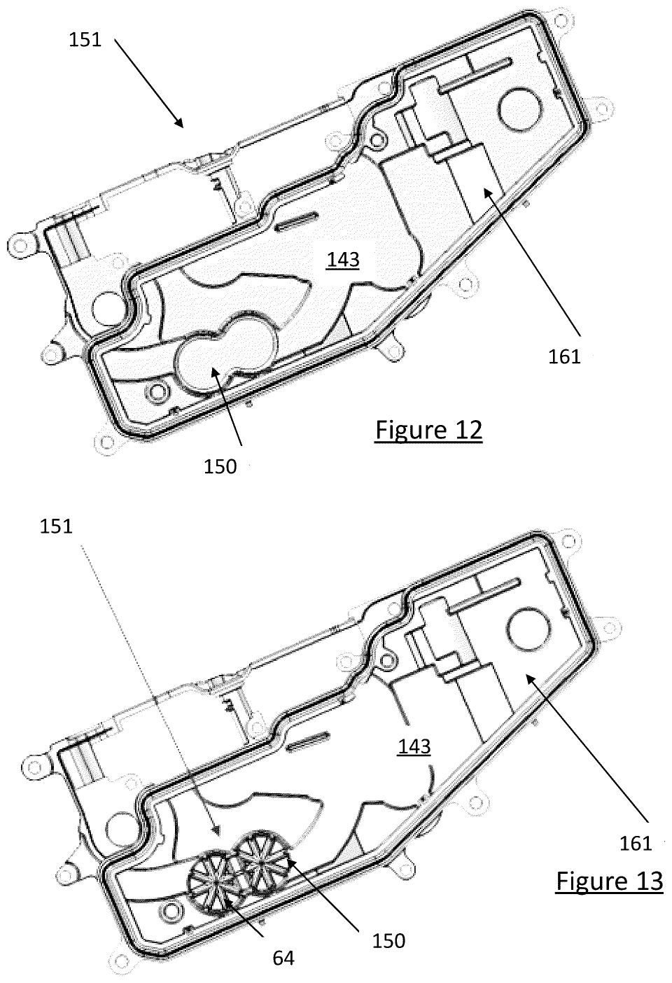

Referring to FIG. 12, shown is a further embodiment of the ECU cover 151, such that an interior surface 161 of the plate segment 143 is shown, along with the enclosure segment 150 (also referred to as component portion 150). It is recognized that the interior surface 161 is opposite to the exterior surface 160 of the plate segment 143. FIG. 13 shows the enclosure segment 150 with a plurality of compression elements 64, as further described below.

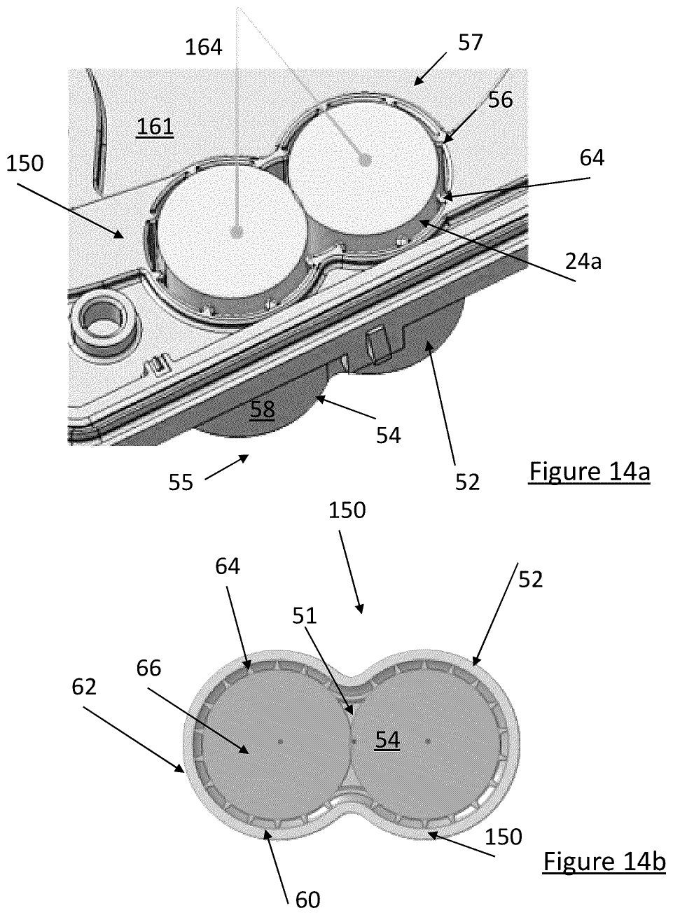

Referring to FIGS. 14a,b, shown is the enclosure segment 150 having a body 52 with a base 54 at one end 55 and an opening 56 at another end 57. Extending between the ends 55, 57, the body 52 has a sidewall 58 having an interior surface 60 and an exterior surface 62. The interior surface 60 (forming an interior 66) has a plurality of compression elements (e.g. ribs 64) spaced apart about a periphery of the sidewall 58, such that the ribs 64 project inwards into the interior 66 from the interior surface 60. The base 54 and the sidewall 58 define the interior 66, which can be referred to as a receptacle for receiving at least a portion of the electronic component 24 (e.g. a super cap). For example, the compression elements 24 can be made of a resilient material (e.g. rubber-of other elastomeric material). It is recognised that the rib 64 structures can be resilient such that they that collapse (e.g. bend or otherwise deform or compress) during the insertion process of the super capacitor 164 (e.g. an electronic component 24 fitted into the interior 66) into the component enclosure 150 (e.g. electrical component 24 housing). For example, the rib structures 64 can be formed as overmold material on the interior surface 60 of the body 52.

As such, during bending or other deformation of the ribs 64, a compressive fit of the electrical component 24 within the component enclosure 150 provides for a snug fit of the electrical component 24 within the component enclosure 150 in order to facilitate compensation for variations in latch housing 150 sizes and/or electrical component 24 sizes, and or assembly processes thereof as desired. As the compression elements 64 are positioned on the interior surface 60 so as to be located between the sidewall 58 and an exterior surface 24a of the electrical component 24.

As shown in FIG. 13, the compression elements 64 can also be located on the base 54, as desired. One advantage of the compression elements 64 is that a compression/interference fit is provided between a latch housing (e.g. the ECU cover 151) and one or more of the electrical components 24 (e.g. the supercaps 164). This interference fit with the supercaps 164 can be provided without the need for additional components (e.g. caps) or resin injected between the exterior surface 24a of electrical component 24 and the latch housing (e.g. ECU cover 151). The compression elements 64 can be applied to the interior surface 60 or can be integral with the material of the body 52.

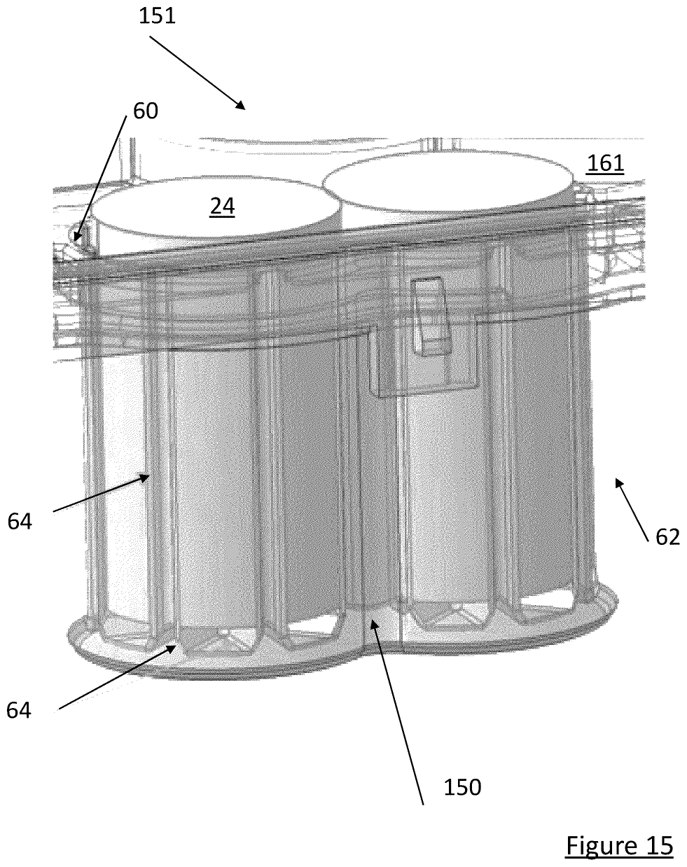

FIG. 15 shows the electrical component 24 mounted in the enclosure segment 150, such that a compression fit is provided between the compressive elements 64 and the exterior surface 24a of the electrical component 24. The enclosure segment 150 is shown in ghosted/transparent view, such that the surfaces 60, 62 are both visible for ease of explanation purposes only. It is also recognized that the compression elements 64 (e.g. ribs) can project from the interior surface a greater distance near the bottom end 55 as compared to the top end 57. In other words, the compression elements 64 can taper in height (e.g. the distance of projection from the interior surface 60) at least a portion of the distance between the ends 55, 57, such that height of the compression elements 64 towards the top end 57 is less than the height towards the closed end 55.

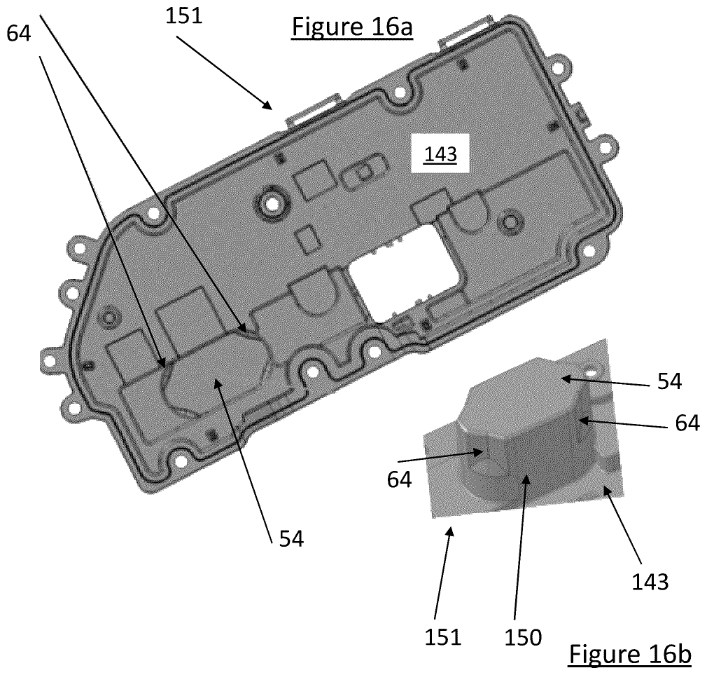

Referring to FIGS. 16a,b, shown is an alternative embodiment of the compression elements 64. For example, the compression elements 64 can be configured as projections 64 of the sidewall 58 material projecting into the interior 66 (see FIG. 14b). As such, the projections 64 can be configured to be somewhat resilient (e.g. elastically or plastically deformable 65), such that contact of the electrical component 24 with the projections 64 could cause the projections 64 to deform in order to provide the desired interference fit. As discussed above, the height of the projections 64 from the interior surface 60 can be variable/selectable during manufacture of the ECU cover 151, so that different sized electrical components 24 can be accommodated with a customizable interference fit.

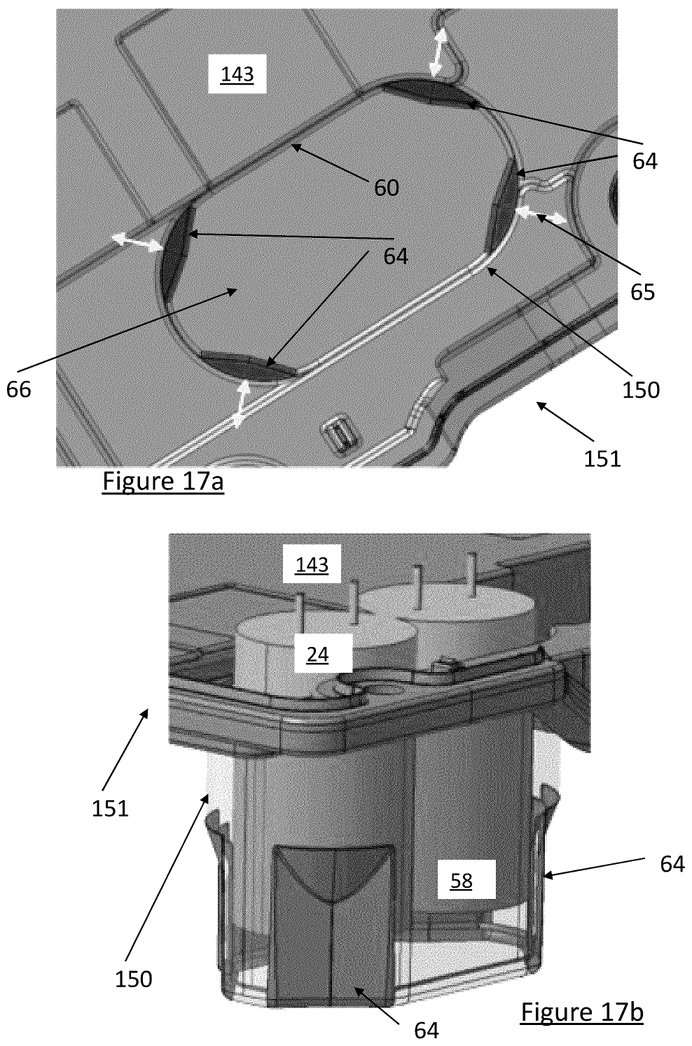

FIGS. 17a,b show unassembled and assembled views.

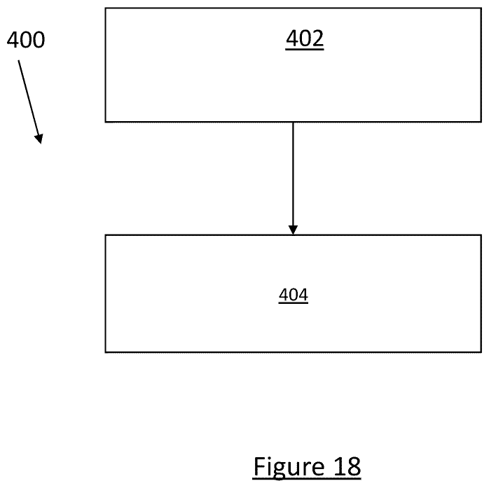

FIG. 18 shows an example method of manufacturing 400 including step 402 providing an enclosure cover 151 of the electronic latch assembly, the enclosure cover 151 having at least one cavity 150 formed therein as a component portion 150 for receiving the electrical component 24, the component portion 150 having an interior 66 having a plurality of compression elements 64 distributed about an interior surface 60 of the interior 66; and step 404 disposing the electrical component 24 into the component portion 150 such that an interference it is formed by deformation of the plurality of compression elements 64 by an exterior surface 24a of the electrical component 24.

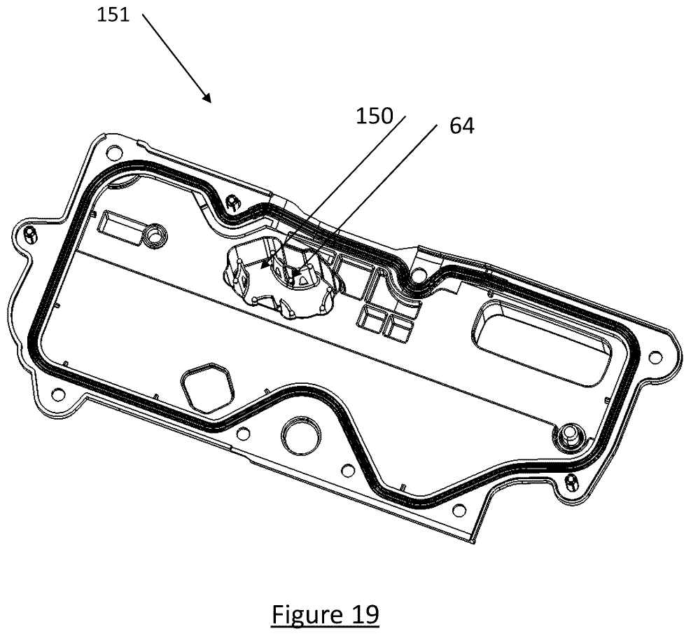

Referring to FIGS. 19-23, a further embodiment of the ribs/compression elements 64 is shown, such that the ribs/compression elements 64 extend from a bottom 54 of the component portion 150 (e.g. project from an interior surface 61.

Referring to FIG. 19, shown is the further embodiment of the ECU cover 151.

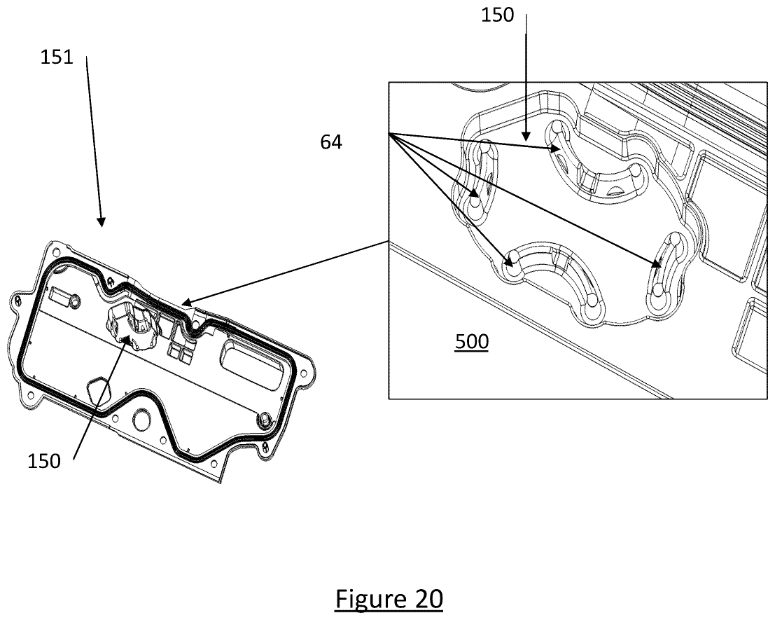

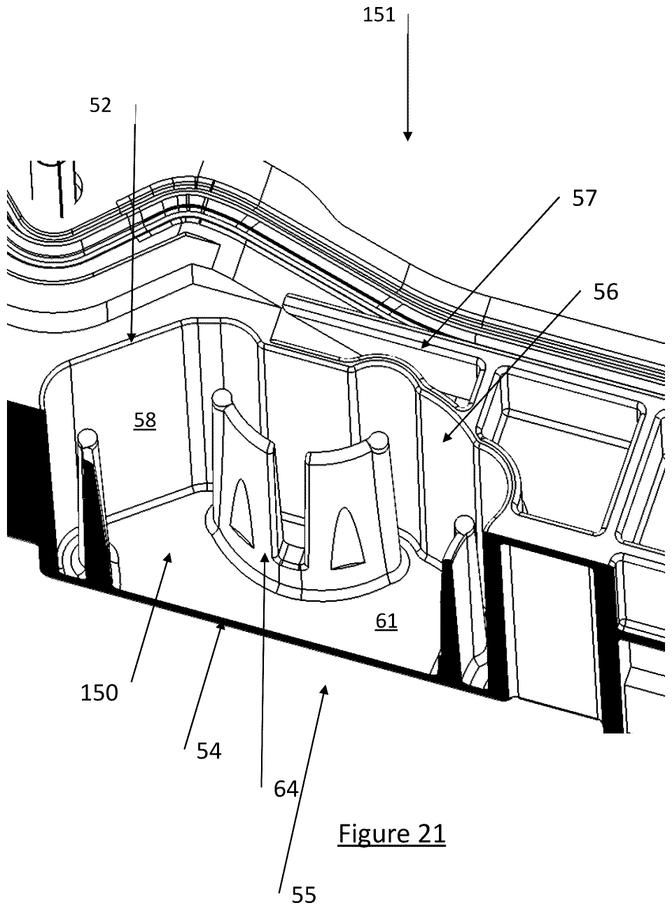

FIG. 20 shows an enlarged view 500 of the component portion 150. For example, the elastic ribs 64 (e.g. made of the same material as the cover) can be used to inhibit problems due to super cap 24 vibrations. Preferably, the ribs 64 are elastic (e.g. resilient) because manufacturers can have variability on the diameter and length tolerances of the components 24.

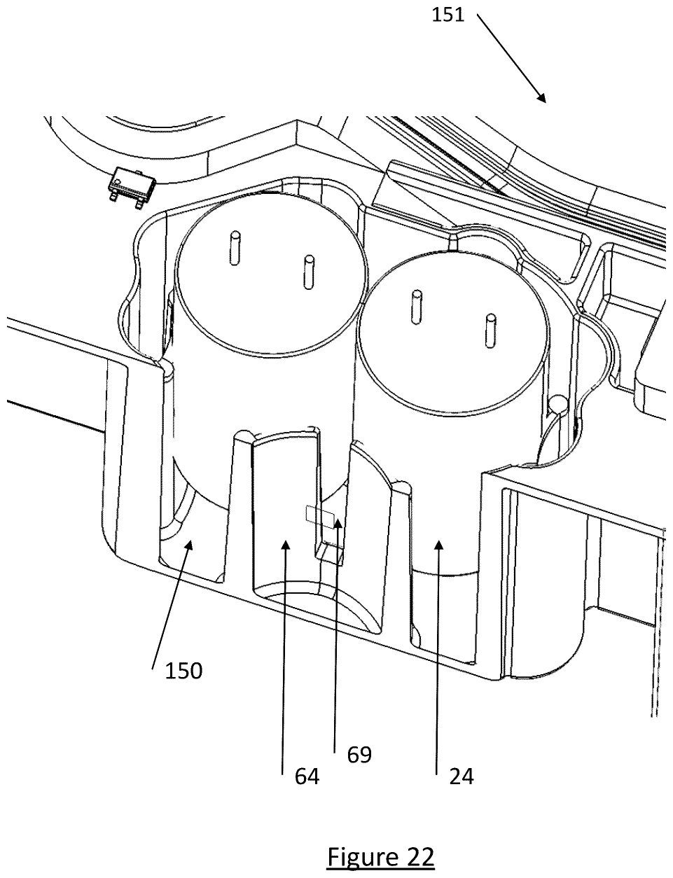

Shown in FIG. 21 is the enclosure segment 150 having a body 52 with a base 54 (having an interior surface 61) at one end 55 and an opening 56 at another end 57. Extending between the ends 55, 57, the body 52 has a sidewall 58.

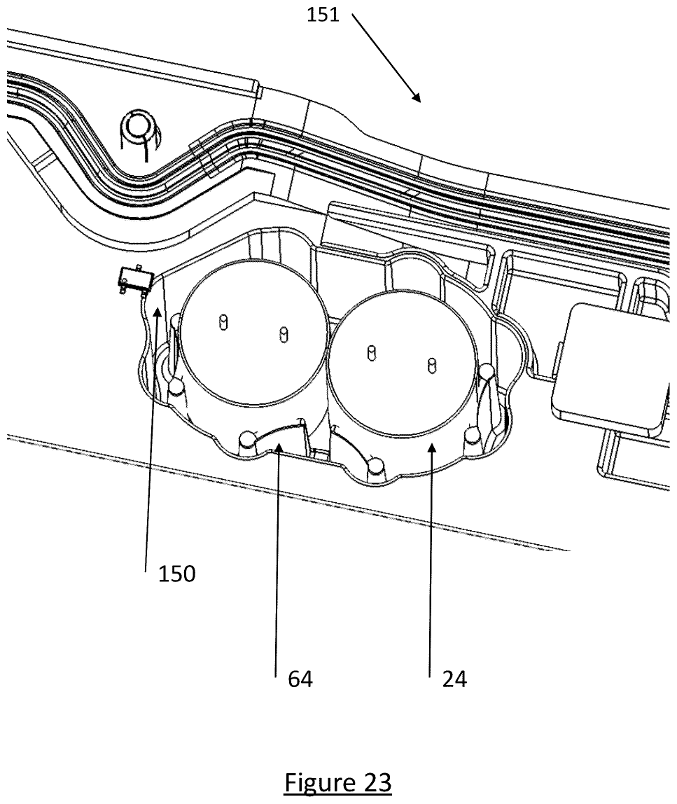

FIGS. 22, 23 shows the components 24 mounted in the component portion 150, such that the ribs 64 are in engagement with the components 24.

The above-described further embodiment has the ribs/compression elements 64 as a separate protruding feature of the component portion 150, such that the ribs/compression elements 64 provide for flexibility when inserting of the supercap (e.g. component 24). The ribs/compression elements 64 projecting from the interior surface 611 (e.g. of the bottom 54) facilitates more flexibility for insertion, as compared to the side wall/housing acting as the retainer, which can be too rigid in some circumstances. For example, the ribs/projections 64 can be formed as curved portions (e.g. an arc) extending from the base 54 of the component portion 150. The ribs/projections 64 can have a slot 69 in order to accommodate adjacent components 24.

We claim:

1. An electronic closure latch assembly (120) for a vehicle (110), the electronic closure latch assembly comprising:
an enclosure cover (151);
a component portion (150) of the enclosure cover sized to retain an electrical component (24) therein, the component portion having an interior (66) having a plurality of compression elements (64) distributed on an interior surface (60,61) of the interior;
an electronic controller (10) disposed within the enclosure cover, the electronic controller including the electrical component;
wherein the plurality of compression elements are deformed against an exterior surface (24a) of the electrical component when the electrical component is inserted into the component portion of the enclosure cover.

2. The assembly of claim 1 further comprising the plurality of compression elements configured as a plurality of projections distributed on the interior surface.

3. The assembly of claim 2, wherein said deformed is facilitated by a deformation of the plurality of projections.

4. The assembly of claim 1, wherein the plurality of projections are formed on the interior surface of a bottom of the component portion.

5. The assembly of claim 1, wherein the compression elements are made of a resilient material.

6. The assembly of claim 1, wherein the electrical component is a super capacitor.

7. The assembly of claim 1 further comprising the plurality of compression elements configured as a plurality of ribs distributed about a periphery of the interior surface of a sidewall of the component portion.

8. The assembly of claim 2, wherein said deformed is facilitated by a deformation of the plurality of projections.

9. The assembly of claim 1, wherein plurality of compression elements are monolithic with the component portion.

10. The assembly of claim 1 further comprising the plurality of compression elements each formed in an arc.

11. The assembly of claim 10 further comprising a slot present in at least one of the plurality of compression elements.

12. A method of assembling an electronic closure latch assembly, the method comprising:
providing an enclosure cover of an electronic latch assembly, the enclosure cover having at least one cavity formed therein as a component portion for receiving an electrical component, the component portion having an interior (66) having a plurality of compression elements (64) distributed on an interior surface (60) of the interior; and
disposing the electrical component into the component portion such that an interference it is formed by deformation of the plurality of compression elements by an exterior surface of the electrical component.

13. The method of claim 12, wherein the compression elements comprise a plurality of projections configured to deform during the insertion of the electrical component into the cavity.

14. The method of claim 12, wherein the compression elements comprise a plurality of ribs configured to deform during the insertion of the electrical component into the cavity.

15. The method of claim 12 further comprising the plurality of compression elements configured as a plurality of projections distributed on the interior surface.

16. The method of claim 12, wherein the plurality of projections are formed on the interior surface of a bottom of the component portion.

17. The method of claim 12, wherein the compression elements are made of a resilient material.

18. The method of claim 12, wherein the electrical component is a super capacitor.

19. The method of claim 12 further comprising the plurality of compression elements configured as a plurality of ribs distributed about a periphery of the interior surface of a sidewall of the component portion.
